(19) United States
(12) Patent Application Publication
(10) Pub. No.: US 2014/0332475 A1
(43) Pub. Date: Nov. 13, 2014

(54) FILTER DEVICE AND METHODS OF USING THE SAME

(71) Applicants: Richard Rubin, Fairfield, NJ (US); Steve Zatechka, Cordova, TN (US); Michael E. Grzelak, Wayne, NJ (US); Anthony Schnepel, Girdletree, MD (US)

(72) Inventors: Richard Rubin, Fairfield, NJ (US); Steve Zatechka, Cordova, TN (US); Michael E. Grzelak, Wayne, NJ (US); Anthony Schnepel, Girdletree, MD (US)

(21) Appl. No.: 13/890,636

(22) Filed: May 9, 2013

(51) Int. Cl. B01D 35/04

(52) U.S. Cl. CPC B01D 35/04
USPC 210/767; 210/348

(57) ABSTRACT

A filter device having a filter and a locking mechanism embedded in an interior of the filter. The locking mechanism is adapted to securely insert the filter into a component.

### FIELD OF THE INVENTION

The present invention relates a filter device and method of using the same. More specifically, the invention relates to an improvement in configuration for the filter device for secure and sealing engagement with another component.

### BACKGROUND OF THE INVENTION

Current filtration methods involve use of either jerry-rigged filters or commercially available filters. However, both of these options have drawbacks. The lab-made option involves manually clipping squares of mesh and engaging in an awkward and messy process to use them. Purchasing rolls of mesh, storage of same in the lab, the need to maintain the institutional knowledge for how to prepare and use them, and the issue of non-sterility, are all negatives for this method.

On the other hand, commercially available filters, which include the so called “cell strainers” that are designed to fit directly on top of, and within the opening of a 50 ml conical tube have drawbacks due to fluid dynamics and surface tensions. These disadvantages either prevent the efficient flow of fluid through the filter or result in back-pressure that often causes the sample to spill over the side of the tube resulting in a loss of sample. Further, each filter must be individually unwrapped and positioned on top of the tube, lending to an inefficient process when processing multiple samples.

The present invention relates a filter device and method of using the same. More specifically, the invention relates to an improvement in configuration for the filter device for secure and sealing engagement with another component. Accordingly, there is a need in the art to provide for a filter device which addresses the drawbacks inherent in the current designs. As such, there is a need in the art for a low cost filter device with requires less manual labor. Also there is a need in the art or an efficient and effective filter device. Also, there is a need for a filter device, which may be utilized with readily available and commonly used pipettes, and may also be utilized after media is aspirated into the pipette.

### SUMMARY OF THE INVENTION

The present invention provides an improved filter device and methods of using the same.

In some embodiments, the filter device includes a filter and a locking mechanism embedded into upper portion of the filter.

In one embodiment, the locking mechanism is a washer encapsulated into material of the filter device.

In some embodiments, locking mechanism provides for secure and sealing engagement of another component into the filter device.

In one embodiment of the present invention, another component is a pipette tip.

In some embodiments there is provided an assembly of a filter device and the pipette tip.

In one embodiment, the assembly includes a filter device securely engaged to the pipette tip through the locking mechanism.

In another embodiment, the assembly prevents the filter device to be removed from the pipette tip.

In some embodiments, the assembly provides for an overlap between material of the filter and wall of the pipette tip, thus creating a seal between the filter and the pipette tip.

In one embodiment, the assembly allows media from the pipette tip to flow directly into lower portion of the filter.

In another embodiment, the assembly prevents media from the pipette tip to enter the locking mechanism and an interior portion of the filter.

### BRIEF DESCRIPTION OF THE DRAWINGS

The present invention will be more readily understood from the detailed description of exemplary embodiments presented below considered in conjunction with the attached drawings, of which:

FIG. 1 is a schematic view of a filter device in accordance with one embodiment of the present application.

FIG. 1A illustrates a cross-section view of the filter device of FIG. 1.

FIG. 2 illustrates a schematic view of an assembly including the filter device of FIG. 1 in accordance with one embodiment of the present application.

FIG. 2A illustrates a cross-section view of the assembly of FIG. 2 in accordance with one embodiment of the present application.

FIG. 2B illustrates a cross-section view of the assembly of FIG. 2 in accordance with another embodiment of the present application.

FIG. 3 illustrates a flow diagram of a method for using the filter device.

### DETAILED DESCRIPTION OF THE INVENTION

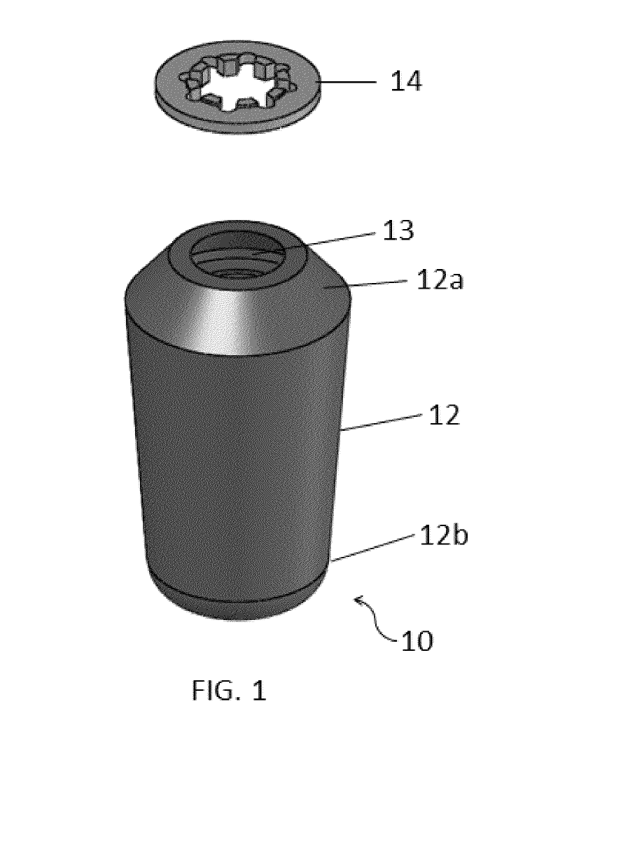

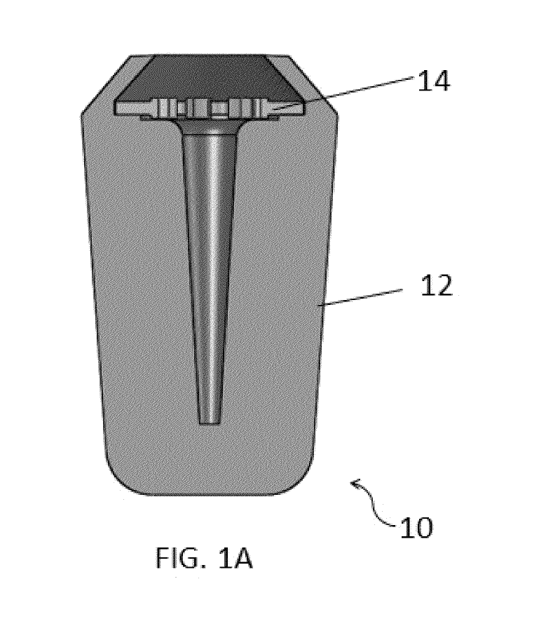

Referring initially to FIG. 1, there is shown a filter device 10 in accordance with one embodiment of the present invention. The filter device 10 includes a filter 12 and a locking mechanism 14. In one embodiment, the filter 12 is a filter media made of selected materials that form the barrier to the passage of filterable suspended solids or dissolved molecules. The selected material may include porous material of a glutinous nature or consistency such as sticky, thick and/or adhesive material. As an example, the porous materials may be sand or paper. As known in the art, filter media may be used to remove undesirable materials from liquid solutions.

In some embodiments, the filter 12 includes a plastic housing enclosing a screen. In one embodiment, the screen has mesh sizes including but not limited to 40, 70 or 100 micrometers (microns).

Referring back to FIG. 1, the filter 12 has a substantially cylindrical configuration. Although, the filter 12 is illustrated to have a substantially cylindrical configuration, one skilled in the art will appreciate that the filter may have other shapes including but not limited to circular, square, rectangular, triangular, conical etc. The filter 12 has a upper portion 12a and a lower portion 12b. The upper portion 10a of the filter 10 has an opening 13 shaped and sized to be inserted into another component (not shown). The lower portion 10b of the filter 10 is shaped and sized to filter out any media (not shown) placed into the filter 10.

As shown in FIG. 1, the locking mechanism 14 has a substantially disc configuration. Although, the locking mechanism 14 is illustrated to have a substantially disc configuration, one skilled in the art will appreciate that the locking mechanism may have other shapes including but not limited to circular, square, rectangular, triangular etc.

In one example, the locking mechanism 14 is a washer. In some embodiments, the locking mechanism 14 is a wire clip. In other embodiment, filter media itself can provide a locking mechanism such as selectively forming hard surface inside the filter 12 Such hard surface may be formed by utilizing heat . In one embodiment, the locking mechanism 14 is permanently fixed into the filter 12. In one embodiment, the locking mechanism 14 is not removable from the filter 12. In one embodiment, the locking mechanism is made of rigid plastic material. In another embodiment, the locking mechanism is made of metal. In one embodiment, the locking mechanism is made of materials including but not limited to plastic, sand and paper.

Referring to FIG. 1A, there is shown a cross-section view of the filter device 10. As shown, the locking mechanism 14 is embedded in the filter 12. Specifically, the locking mechanism 14 is encapsulated or captured within the material of the filter 12. The locking mechanism may be encapsulated within the filter by methods such as heat staking, press fitted into a ledge or other methods. In one embodiment, the heat staking is applied on exterior of upper portion 12a of the filter which provides a secondary seal at upper portion 12a.

In one embodiment of the present invention, the locking mechanism 14 of the filter device 10 functions to provide a secured attachment of the filter into another component (not shown) as will be described in greater detail below.

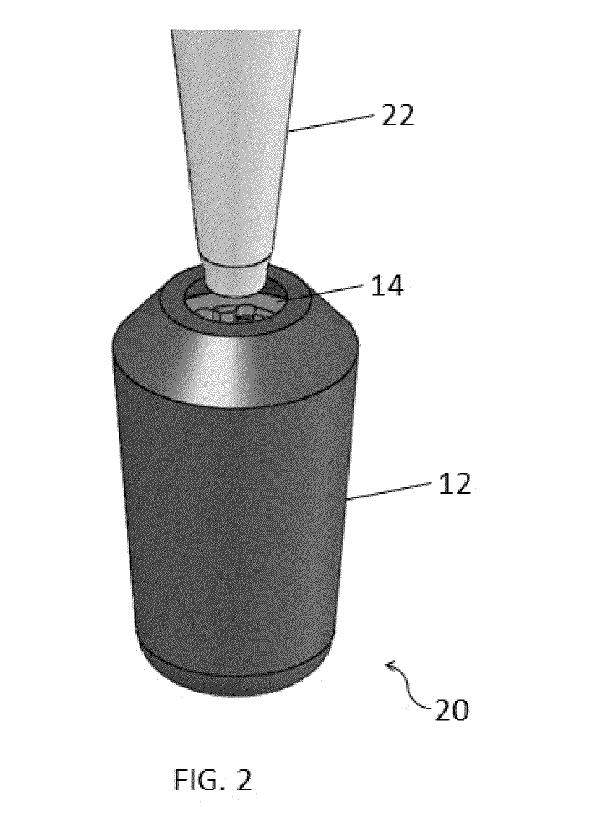

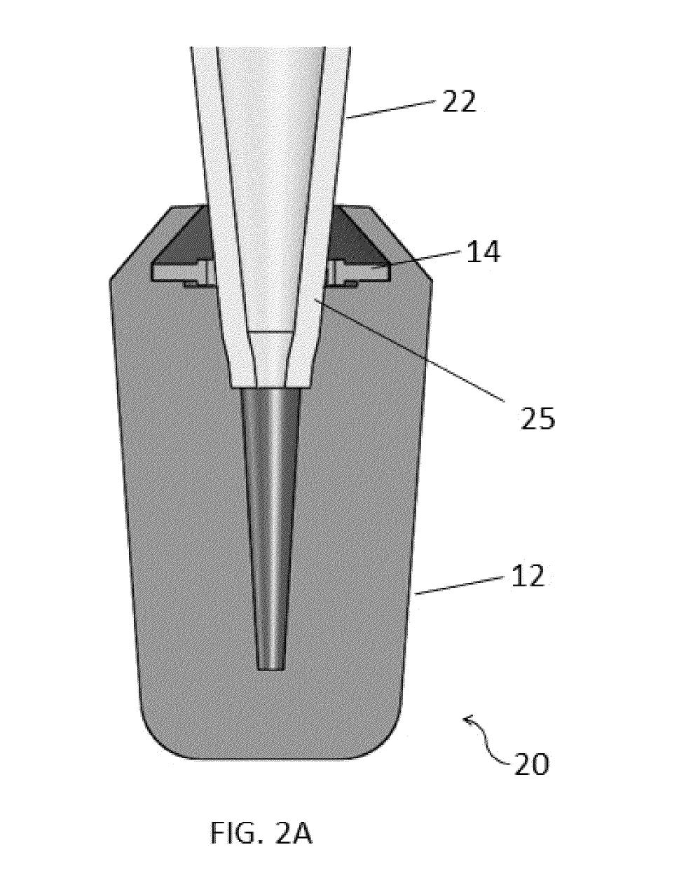

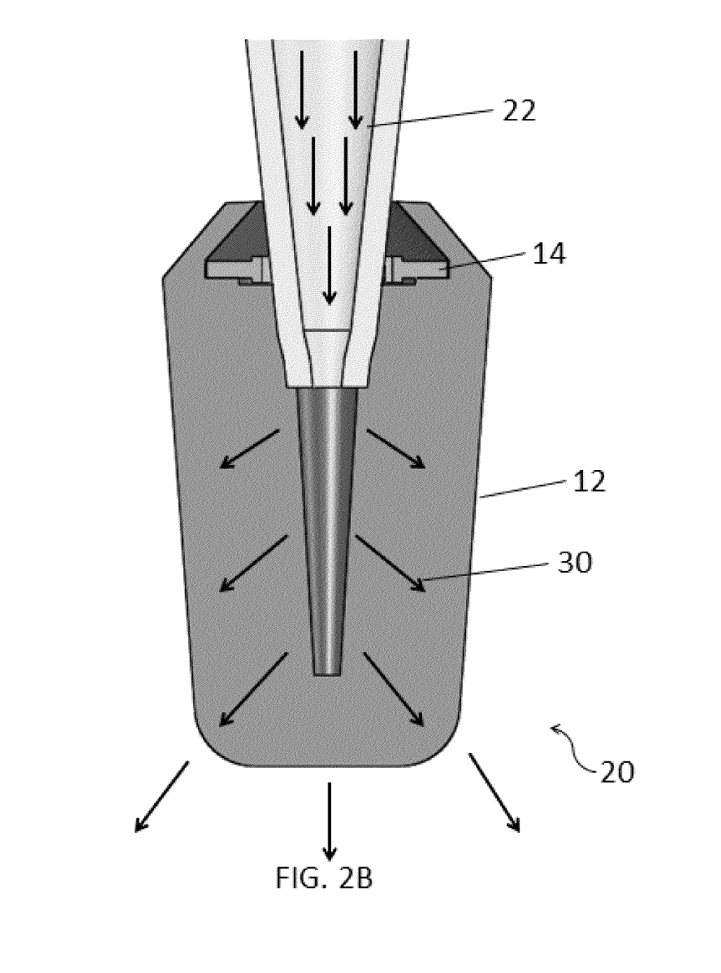

FIG. 2 illustrates a view of an assembly 20 of a filter device 10 inserted into another component 22. As shown in FIG. 2, in one example, the other component 22 is a pipette tip. In one embodiment, a force is applied to the pipette tip 22 to push into the locking mechanism 14, thus locking the pipette tip 22 into the filter 10. As such, the filter device 12 functions to secure the pipette tip 22 and provide a seal around the pipette tip 22, details of which will be provided below.

FIG. 2A illustrates an enlarged cross-section view of the assembly 20 of FIG. 2. As shown in FIG. 2A, the filter 12 may be inserted into the pipette tip 22 via the locking mechanism 14. Specifically, a force is applied to the pipette tip 22 to push into the locking mechanism 14, thus locking the pipette tip 22 into the filter device 12. As such, the locking mechanism 14 securely holds and locks the filter 12 into the pipette tip 22. Such assembly 20 of the filter 12 into the pipette tip 22 prevents the filter 12 to be removed from the pipette tip 22. As such, the filter device 10 is permanently affixed to the pipette tip 22. In one embodiment, the pipette tip 22 is made of tubular materials. Such materials include polypropylene . In one embodiment, the pipette tip 22 is shaped and sized for insertion of the filter device 10. As an example shown in FIG. 2A, the pipette 22 is of substantially hollow, elongated, generally conical shape.

In another embodiment of the present invention, the filter device 10 functions to provide a secure seal from media when another component is inserted into the filter 12 as will be described in greater detail below. The media may include but is not limited to fluid, polypropylene etc.

Referring back to FIG. 2A an overlap 25 is present between the filter 12 and wall of the pipette tip 22. Since, the filter 12 is made of generally soft material and the pipette tip 22 is made of generally rigid material, an overlap 25 occurs between the filter 12 and the pipette tip 22. Specifically, the overlap 25 occurs between material of the filter and material of wall of the pipette tip 22. Such overlap 25 prevents the filter 12 from being squeezed and/or crushed into the pipette tip 22. As result, a seal is created due to the overlap 25 between the pipette tip 22 and the filter 12. When you push this tip through the washer to the filter, this overlap pushing the material and squeezing it to create a seal around the tip at the same time washer is locking into the tip. So, it is securing and also sealing around the tip.

Referring to FIG. 2B, there is shown a cross-section view of the assembly 20 of FIG. 2A with media (illustrated by arrows) 30 flowing from the pipette tip 22 into the filter device 10. As shown, the media 30 flows from the pipette tip 22 directly into the filter device 10. Due to the seal created by the overlap 25, the media 30 actually flows past and around the locking mechanism 14. Also, the media 30 is dispensed by the pipette tip 22 at a force such that it pushes through bottom of the pipette tip 22 and flows directly downwards into interior of the lower portion 12b of the filter 12 and away from the interior of the upper portion 12a of the filter 12. As such, the media 30 does not enter the interior of the upper portion 12a filter 12 including the locking mechanism 14.

In one embodiment, heat staking is applied on exterior of upper portion 12a of the filter which provides a secondary seal at upper portion 12a. In one embodiment, the heat staking creates a skin on the upper portion 12a of the exterior of the filter 12, which transforms the porous material at the upper portion 12a into non-porous, As such, this secondary seal will stop the media from coming out through the upper portion 12a of the filter.

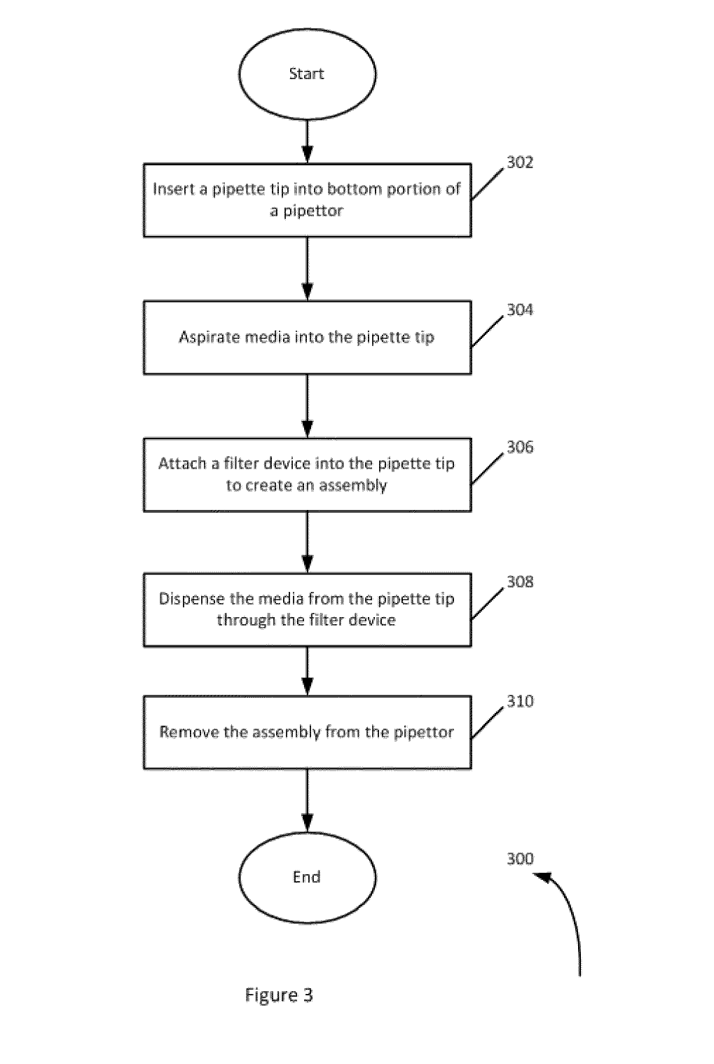

Referring to FIG. 3, there is shown a flow chart of a method 300 of using the filter device 10 in accordance with an embodiment of the present invention. At block 302, a pipette tip is inserted to a bottom portion of a pipettor. In one embodiment, the pipette tip is the pipette tip 22 as illustrated in FIG. 2. At block 304, a media is aspirated into the pipette tip. In one embodiment, the media is aspirated from a container. In one embodiment, a force (such as a spring-loaded plunger) is applied from an upper portion of the pipettor in order to aspirate the media into the pipette tip. At block 306, the filter device is attached into the pipette tip to create an assembly. In one embodiment, the filter device is the filter device 10 as illustrated in FIG. 1. In one embodiment, the assembly is the assembly 20 of FIG. 2.

At block 308, the media is dispensed from the pipette tip through the filter device and into any variety of vessels designed to capture and contain the filtered media. Accordingly, the media is removed from filter device without any spills and/or loss of the solution, thus providing for improved handling of collection and extraction of the media. Accordingly, the filter device functions to filter out the media. In one embodiment, the filtered media is dispensed into a collection container for performing various tests. Such testing may include, but not limited to analyzing the filtered solution, counting number of cells in the filtered solution. In another embodiment, the filtered media is connected to a port of a device. At block 310, the assembly of the pipette tip and the filter device is removed from the pipettor. In one embodiment, the assembly is disposed.

It is to be understood that the exemplary embodiments presented herein are merely illustrative of the invention and that many variations of the above-described embodiments may be devised by one skilled in the art without departing from the scope of the invention.

1. A filter device comprising:
a filter; and
a locking mechanism embedded in an interior of the filter, wherein the locking mechanism is adapted to securely insert the filter into a component.

2. The filter device of claim 1, wherein the filter comprises an upper portion and a lower portion.

3. The filter device of claim 2 wherein the locking mechanism is encapsulated into the upper portion of the interior of the filter to permanently attach the filter into the component.

4. The filter device of claim 3 wherein an overlap occurs between the interior of the upper portion of the interior of the filter and the locking mechanism.

5. The filter device of claim 4 wherein a seal is created based on the overlap.

6. The filter device of claim 5 wherein the seal prevents media to flow into the upper portion of the interior of the filter.

7. The filter device of claim 5 wherein the seal allows the media to flow directly into the lower portion of the interior of the filter.

8. The filter device of claim 2 wherein a secondary seal is created on exterior of the upper portion of the filter.

9. The filter device of claim 1 wherein the locking mechanism comprises a washer.

10. The filter device of claim 1 wherein the filter device is a filter media.

11. The filter device of claim 1 wherein the filter device comprises porous material.

12. The filter device of claim 1 wherein the component is a pipette tip.

13. A method of using a filter device, the method comprising:
inserting a filter device into a component, wherein the filter device comprises a filter and a locking mechanism embedded in an interior of the filter, wherein the locking mechanism is adapted to securely insert the filter into the component.

14. The method of claim 13 further comprising dispensing a media from the component through the filter device, wherein the media flows directly into a lower portion of the interior of the filter.

15. The method of claim 14 wherein the media is prevented to flow into an upper portion of the interior of the filter.
